(19) United States
(12) Patent Application Publication
(10) Pub. No.: US 2014/0281859 A1
(43) Pub. Date: Sep. 18, 2014

(54) ENHANCED MOBILIZATION OF EXISTING WEB SITES

(71) Applicant: International Business Machines Corporation, Armonk, NY (US)

(72) Inventors: Erik J. Burckart, Raleigh, NC (US); Gennaro A. Cuomo, Cary, NC (US); Dinakaran Joseph, Apex, NC (US); Todd E. Kaplinger, Raleigh, NC (US); Victor S. Moore, Lake City, FL (US); Gregory L. Truty, Austin, TX (US)

(73) Assignee: International Business Machines Corporation, Armonk, NY (US)

(21) Appl. No.: 14/079,100

(22) Filed: Nov. 13, 2013

Related U.S. Application Data
(63) Continuation of application No. 13/801,892, filed on Mar. 13, 2013.

(51) Int. Cl. G06F 17/22

(52) U.S. Cl. CPC G06F 17/2235
USPC 715/205

(57) ABSTRACT

Mobile enablement of a web site, in one aspect, may comprise separating the web application into a static content and a dynamic content, the dynamic content comprising one or more data sources from which to retrieve data at runtime of the web application; rendering the static content as one or more hypertext markup language pages with one or more links between the hypertext markup language pages converted to local links; changing one or more references to the dynamic content to representational state transfer requests; enabling the representational state transfer requests from the one or more hypertext markup language pages; enabling use by the one or more hypertext markup language pages of at least one HTML5 feature that is accessible on the mobile device; and packaging the one or more hypertext markup language pages as the mobile application.

### CROSS-REFERENCE TO RELATED APPLICATIONS

This application is a continuation of U.S. application Ser. No. 13/801,892, filed Mar. 13, 2013, which is related to commonly-owned, co-pending U.S. patent application Ser. No. 13/801,924 entitled, “TRANSFORMING APPLICATION CACHED TEMPLATE USING PERSONALIZED CONTENT”, filed on Mar. 13, 2013; U.S. patent application Ser. No. 13/801,820 entitled, “MOBILE ENABLEMENT OF WEBPAGES”, filed on Mar. 13, 2013; U.S. patent application Ser. No. 13/801,848 entitled, “MOBILIZING A WEB APPLICATION TO TAKE ADVANTAGE OF A NATIVE DEVICE CAPABILITY”, filed on Mar. 13, 2013; and U.S. patent application Ser. No. 13/801,830 entitled, “MOBILE ENABLEMENT OF EXISTING WEB SITES”, filed on Mar. 13, 2013, the entire contents and disclosures of which are expressly incorporated by reference herein as if fully set forth herein.

### FIELD

The present application relates generally to computers, and computer applications, and more particularly to mobile device applications and converting existing web sites as mobile applications.

### BACKGROUND

A mobile application (also referred to as mobile app) refers to a software application that is run on a mobile device. Existing web sites are usually developed for access by a desktop computer or the like with full capacity to screens, networking bandwidth, connection, and others. For at least those reasons, accessing those web sites from a mobile device (e.g., those that might experience network disconnects or loss as the device moves from one area to another, narrow bandwidth, and other characteristics inherent in mobile devices) proves to be inefficient.

As another aspect, a mobile app is deployed into an “App Store”, when it is created. Whenever any updates are needed to be done to the mobile app, the entire updated mobile app is loaded back into the App Store. Once the mobile app is updated on the App Store, the entire application is then downloaded to the mobile device and reinstalled. Current known methodologies do not allow for selective updates, it is not possible to perform partial updates of an application using known solutions.

### BRIEF SUMMARY

A method of converting a web application to a mobile application, in one aspect, may comprise separating the web application into a static content and a dynamic content. The dynamic content may comprise one or more data sources from which to retrieve data at runtime of the web application. The method may also comprise rendering the static content as one or more hypertext markup language pages with one or more links between the hypertext markup language pages converted to local links. The method may further comprise changing one or more references to the dynamic content to representational state transfer requests. The method may also comprise enabling the representational state transfer requests from the one or more hypertext markup language pages. The method may further comprise enabling use by the one or more hypertext markup language pages of at least one hypertext markup language version 5 (HTML5) feature that is accessible on the mobile device. The method may further comprise packaging the one or more hypertext markup language pages as the mobile application.

A system converting a web application to a mobile application, in one aspect, may comprise a conversion module operable to execute on a processor, the conversion module further operable to separating the web application into a static content and a dynamic content, the dynamic content comprising one or more data sources from which to retrieve data at runtime of the web application. The conversion module may be further operable to render the static content as one or more hypertext markup language pages with one or more links between the hypertext markup language pages converted to local links. The conversion module may be further operable to change one or more references to the dynamic content to representational state transfer requests to enable the representational state transfer requests from the one or more hypertext markup language pages. The conversion module may be further operable to enable use by the one or more hypertext markup language pages of at least one HTML5 feature that is accessible on the mobile device. The one or more hypertext markup language pages may be packaged as the mobile application.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is an overview of a method for converting a web application to a mobile application or hybrid mobile application in one embodiment of the present disclosure.

FIG. 2 is a flow diagram illustrating a method of converting dynamic content of a web application to a model such as RESTful data model based resources in one embodiment of the present disclosure.

FIG. 3 is an example form field that allows users to update their profile.

FIG. 4 illustrates example of data modeled in JavaScript Object Notation (JSON) to denote the attributes associated with the REST request.

FIG. 5 illustrates an example of an updated client (application) based upon the parsed data model.

FIG. 6 illustrates an example of REST API for retrieving data based upon the model.

FIG. 7 is a diagram illustrating a mobile application packaged according to one embodiment of the present disclosure.

FIG. 8 is a flow diagram illustrating a method in which mobile app deployed on a mobile device may be updated, in one embodiment of the present disclosure.

FIG. 9 illustrates a schematic of an example computer or processing system that may implement a system that enables conversion of a web site application to a mobile application in one embodiment of the present disclosure.

FIG. 10 illustrates an architectural overview of mobile enablement of web sites in one embodiment of the present disclosure.

FIG. 11 illustrates a conventional desktop browser based application (in this example, the web resource is a store locator form).

FIGS. 12-14 depict various diagrams showing an example implementation of operation according to an embodiment of the present disclosure.

FIG. 15 depicts a diagram showing an example implementation of operation according to an embodiment of the present disclosure.

FIG. 16 is a flow diagram illustrating a method in one embodiment of the present disclosure.

FIG. 17 illustrates an architectural overview of a system in one embodiment of the present disclosure.

### DETAILED DESCRIPTION

In one embodiment of the present disclosure, a methodology is presented that enables users or customers of a web site or the like (e.g., client/server application), for example an existing web site, to create a mobile web site. For instance, the methodology of the present disclosure in one embodiment may provide for the mobile enablement of the existing web server or application server (e.g., WebSphere™) customers that already have investments in traditional Internet Web Sites. In one aspect, the methodology of the present disclosure may create a mobile web site from the JavaServer Pages (JSPs) of an Internet Web site.

The methodology of the present disclosure in one aspect converts an existing Internet Web site into a functionally equivalent “mobile client and mobile gateway” so that the Web site can be accessed and used efficiently via mobile devices. Examples of a mobile device may include, but not limited to, a cell phone, smart phone, tablet, laptop computer, and/or others. Consider a conventional Web site, created via tooling like Eclipse™. Here the web site is composed of one or more JSPs. In one embodiment of the present disclosure, a plugin for Eclipse™ is created that reads the JSP pages from the web site above and renders the hypertext markup language (HTML) for each page into a file. Within this HTML the navigational links between these pages are changed to local links. In addition, the associated JSPs are analyzed to determine which items on these HTML pages are dynamic data. Dynamic data or dynamic content refers to data whose values are obtained for displaying on a web page, e.g., as opposed to having the data value pre-specified in the HTML page. Dynamic data, e.g., may be caused to be displayed via a scripting language, e.g., embedded in the web page. So for example, a dynamic web page includes dynamic content that changes, e.g., based on user input, attributes or parameters, computer program, and/or another criterion. The methodology of the present disclosure in one embodiment modifies these JSPs to create a new set of JSPs that offer RESTful interfaces to the logic for each dynamic tag. REST stands for Representational State Transfer. This new set of HTML pages is called the mobile gateway for the web site. These tags, and their associated RESTful interfaces, are correlated with their companion dynamic tags within the HTML pages above. Next, the dynamic tags in the HTML are replaced by RESTful calls to the RESTful interfaces of the mobile gateway.

To create a mobile app the HTML pages are packaged collectively into a bundle with an icon and an interface to the “web browser” for the operating system (OS) of the mobile device. This collection constitutes a mobile app, which is deployable to an app store or the like, e.g., the iTunes app store and other app stores. An app store refers to an online store for downloading software applications and/or mobile applications, e.g., by purchasing or free of charge.

A more sophisticated mobile app has embedded within this package a local JavaScript based client side aggregator. This aggregator batches requests from the mobile application for dynamic content and sends them to the mobile gateway in a single message. This greatly reduces network chatter and bandwidth by assembling multiple requests for dynamic data into a single request. It receives back a single response which the aggregator breaks into separate responses, one for each originating request.

Once the app is deployed to an app store it can then be downloaded to a mobile device. The apps icon is displayed on the device's home screen, and clicking on this icon will evoke and display the corresponding HTML pages on the mobile devices screen. Within these HTML pages the associated dynamic data is fetched from the respective mobile gateway. In one embodiment of the present disclosure, this is achieved via the embedded restful commands or the like.

Navigation among the HTML pages in an app occurs locally and thus requires no network access. This reduces network traffic and thereby improves the user experience. As each page is displayed the dynamic data for that page is fetched. There is no need to fetch either the pages HTML or JavaScript because they are already loaded onto the mobile device as part of the app. This saves network resources, makes the gateway more scalable and further improves the user experience.

The HTML and JavaScript are part of the app and are thus not fetched over the cellular network. This reduces network traffic and the load on the server. This is particularly valuable if the HTML pages include JavaScript for analytics. Dynamic data is fetched via restful means. Thus the link between the mobile client and the server is asynchronous and is thus well suited to surviving network disconnects and adapting to power saving protocols where the app is put to sleep. Using standard mobile OS techniques the app is awoken when a message is received from the server. Using restful messages is both network friendly and resource efficient. Having the HTML graphical user interface (GUI) local on the client improves the apps responsiveness to manipulation by the user. The mobile gateway provides the app with restful interfaces to the back end data. These interfaces are both network friendly and resource efficient. Multiple request for dynamic data from the app can be aggregated together to minimize the number of messages (and the amount of data) flowing over the network. This reduces the network latency experienced by the user.

A methodology of the present disclosure in one embodiment converts existing web site to a mobile friendly one that may include a mobile client and a mobile gateway. The gateway here may be a server that houses the RESTful interfaces and connectors to the back end data. A vast number of web sites may benefit mobile enablement.

FIG. 1 is an overview of a method for enabling existing web sites to be mobile, e.g., converting a web application to a mobile application or hybrid mobile application in one embodiment of the present disclosure. Briefly, a native application refers to an application that is developed to run a specific platform, e.g., using one or more resources, e.g., operating system specific to that platform. Similarly, a native mobile application refers to an application written to run on specific mobile device. On the other hand, platform independent codes or program such as those written in JAVA or the like may be written once and run anywhere. A hybrid mobile application refers to an application comprising both native and platform independent codes, e.g., platform independent code wrapped inside a native container. The method may include separating a web application into a static content and a dynamic content with data sources at 102. For example, the dynamic content may include one or more data sources from which to retrieve data at run time of the web application. The method may further include rendering the static content as HTML pages with the links between the HTML pages converted to local links and references to dynamic content changed to REST requests at 104. In one embodiment, the code may be separated into modules. For example, the HTML containing the static content and then an import of a JavaScript library may be referenced in the static HTML page to make the REST calls to obtain the dynamic data, enabling one or more REST requests from the HTML page. The REST requests may be also inserted to the HTML pages. The method may also include packaging the HTML pages as a mobile application that can be down loaded from an app store to a mobile device at 106.

The method may further include utilizing a mobile gateway on a remote server for accessing the dynamic content with the data sources at 108. The application further may include a native library for accessing device specific features, application code, JavaScript, HTML, cascading style sheets (CSS), RESTful interfaces for each dynamic tag, and other application artifacts, e.g., icons, images, and/or an application manifest indicating version information for each component of the application. Thus, in one embodiment of the present disclosure, an application may comprise a set of resources, e.g.: 1) static HTML resources representing the view; 2) JavaScript resources to make the REST calls; 3) JavaScript resources that bridge to the native API calls (this is hybrid); 4) native libraries; 5) CSS resources for formatting and styling the HTML.

The method may also include at 110, utilizing the application manifest for identifying component difference between a local version of the mobile application on a mobile device and a remote version of the mobile application resident on a remote server. The method may further include at 112, updating the mobile application selectively by only updating the HTML and JavaScript of the local mobile application with the changes from the remote version.

As one example, dynamic content that is represented in a Web 1.0 style application, e.g., Groovy Templates, JSP and PHP, may be modeled. In that way, the dynamic aspects can be extracted from the static components of the web page creating a static html version of the application that can be hosted by any “web server”. With the extracted dynamic components, the methodology of the present disclosure in one embodiment may use this model (data model associated with dynamic content of the web application) to generate a REST API for obtaining this dynamic data. An advantage of this solution is that by separating the HTML from the dynamic content, intermediaries can cache the static HTML resources and leverage the REST protocol for caching any of the services that are exposed via the REST API for the various CRUD operations (CREATE, RETRIEVE, UPDATE, DELETE).

A “web server” in the present disclosure refers to any server that is capable of file serving of static html resources (e.g., webkit containers for hybrid mobile applications such as PhoneGap™ or typical web servers such as Apache™), e.g., via hypertext transfer protocol (HTTP) requests, versus an application server such as WebSphere™ Application Server serving content such as JSPs or CGI plugins that can be used for executing script based languages such as PHP on Apache.

FIG. 2 is a flow diagram illustrating a method of converting dynamic content of a web application to a model such as RESTful data model based resources in one embodiment of the present disclosure. FIG. 3 is an example form field that allows users to update their profile. This example illustrates using a very simple HTML form to help describe how this could be done. This is by no means limited to this simple use case but it should help describe how this could be implemented. In this example, the sample JSP page contains a standard JavaBean that contains user profile information. This JSP is composed of mostly HTML content with some input fields that are populated by data retrieved by the JavaBean (POJO). A web page or application may utilize other dynamic components, e.g., other reusable software component not limited to JavaBean, and others.

Referring to FIG. 2, at 202, the content of a web application document may be parsed to build a map of dynamic code references. The parsing of the document is performed to locate any dynamic content. In the example shown in FIG. 3, the method of the present disclosure may find one scriptlet that retrieves a ProfileBean object based upon the logged in user. For example, remoteUser contains the user subject's log in identification (id). Once this bean is instantiated, the form will reference this bean to provide the current values that it has for that user.

At 204, data model is generated based on the map of dynamic code references (also referred to as a reference map). The data model, e.g., specifies the variable names or object names that needs to be dynamically resolved at runtime. FIG. 4 illustrates an example data modeled in JavaScript Object Notation (JSON) to denote the attributes associated with the REST request.

At 206, client code (application) or client-side code is updated to retrieve and update dynamic content via REST. Using the data model defined at 204, the method of the present disclosure in one embodiment refactors the web resource (application) or the code to remove the references to dynamic scripting that is executed on the server side. In this example, Dojo may be leveraged to invoke a REST application program interface (API) that is running on the server to obtain the ProfileBean that has been modeled at 204. In response to receiving the content from the server, the method of the present disclosure in one embodiment dynamically via JavaScript updates the various form fields that had previously been populated server side.

FIG. 5 illustrates an example of an updated client (application) based upon the parsed data model. The example code replaces the dynamic content in the code shown in FIG. 3. Lines 8-22 of the example code show invoking of REST to obtain the ProfileBean.

At 208, server code is implemented to expose data model via REST. FIG. 6 illustrates an example of REST API for retrieving data based upon the model. The method of the present disclosure in one embodiment creates a RESTful resource implementation that can retrieve the content. In this example, a servlet is wired as the RESTful resource. In this code, the ProfileBean is retrieved and populated based upon the logged in user. Once this action is performed, the content is transformed to XML and returned to the user.

The following illustrates an example of the content that is returned:

GET /resources/profileBean
result:
{
“firstName” : “Tom”,
“lastName” : “Smith”,
“email”: “tom.smith@us.ibm.com”,
“sex” : “MALE”
}

FIG. 7 is a diagram illustrating a mobile application packaged according to one embodiment of the present disclosure. A native library 702 comprises executable objects that can run on a mobile device. The native library 702 is used to access the device specific features. An application code 704 that has been converted from the web application performs its functions on the mobile device, and for example, may invoke one or more of functions of the native library 702. The application code may also utilize JavaScript, HTML, and/or CSS 706 executable on the mobile device. RESTful interfaces 708 for each dynamic tag is used to obtain the dynamic data from the web server. HTML file 710 contains static content of the code 704. Other application artifacts 712 such as icons, images, and others may be used in invoking the mobile application. In one aspect, the application code 704 comprises basic conversion from using web 1.0 styling or the like with JSPs to the RESTful or the like; The application code at 706 extends the code at 704 to also include the ability to use the native device APIs. The application code 706 may be further enhanced for a mobile device.

The entire contents may be packaged and deployed on an app store or the like that can be downloaded and installed on mobile devices. This helps the user to not have to retrieve every page from a server (since it is all packaged as part of the app) and the application feels like a native application.

In one embodiment of the present disclosure, such mobile application so deployed on a mobile device may be selectively updated, e.g., in optimized fashion. For instance, when an enterprise or like wants to update the mobile app, the enterprise can do so by the traditional way of packaging the entire mobile app and uploading to the app store and allowing the users download the entire app again to their devices.

Another way of updating a mobile app is to selectively update it. In one embodiment of the present disclosure, as part of packaging the mobile app, for example, an app manifest is added that has the information on the version of each component of the app.

An example of an appManifest is shown below:

appManifest
applicationVersion : version number
page1Version : version number
page2Version : version number
...
nativeLibraryVersion : version number

A mobile application may be deployed to an app store and also to a mobile server. The mobile server may run within the enterprise and services the enterprise's mobile applications to its users. When users want to install the application initially, they go to the app store to install it, e.g., the application is downloaded from the app store and deployed onto the user's mobile device. FIG. 8 is a flow diagram illustrating a method in which mobile apps installed on a mobile device may be updated in one embodiment of the present disclosure. At 802, a mobile application running on a mobile device may connect to a mobile server or the like, e.g., run by an enterprise providing the mobile application to its customers or users. At 804, the mobile application downloads an app manifest file associated with the mobile application from the mobile server or the like. At 806, it is determined whether the version number associated with the application specified in the downloaded app manifest file different from the current mobile application's version number, e.g., by examining the version number specified in the app manifest file previously downloaded and stored on the mobile device. If the application version number is different, at 808, one or more components that have different version numbers are determined, e.g., by comparing the content of the downloaded app manifest file with the previously downloaded one.

In one embodiment of the present disclosure, one or more components that have different version numbers may be downloaded, and stored locally on the mobile device at 810, which has the effect of updating the mobile application immediately. Further, at 814, the app manifest file is updated with one or more version numbers corresponding to the one or more downloaded components.

In another embodiment of the present disclosure, one or more components that have different version numbers may be marked at 812. At 816, when or in response to detecting a user navigating to, or using, the marked component of the mobile application, the component may be updated by downloading it from the app store. The app manifest file is also updated with the version number of the downloaded and updated component.

The app manifest file need not be limited to the format shown above. For instance, the app manifest file need not be one file containing information about all of the components; rather, there may be an app manifest file for a component. Other format may be utilized as app manifest file.

With the method shown in FIG. 8, it becomes very easy to update parts of the mobile application. The application still looks and feels like a native application since all the HTML, JavaScript, CSS needed are packaged as part of the app and the user does not have to wait to download the artifacts every time. The mobile app provider can not only upgrade but also rollback changes easily by updating the artifacts hosted in the mobile server within the enterprise.

This method also provides the ability for the provider to selectively open up functionality to different sets of users. Depending on the user credentials, parts of the application can be updated to provide new features.

FIG. 10 illustrates an architectural overview of mobile enablement of web sites in one embodiment of the present disclosure. A web site 1002 or a web application that displays or presents such site may be converted into a mobile application, e.g., as described above. The mobile application so converted may be stored in an app store 1004. One or more mobile devices (e.g., 1010, 1012) may download the mobile application from an app store or the like 1004, e.g., over a network 1008. Updates to one or more components of the mobile application associated with web site 1002 may be performed via a mobile server or gateway 1006. Such server or gateway 1006 may store or retrieve the updated components which may be downloaded to a mobile device, e.g., 1010, 1012.

FIG. 9 illustrates a schematic of an example computer or processing system that may implement the system that provides mobile enablement of web site in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 9 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As described herein are various mechanisms to enable users to create a mobile website. In this regard, FIG. 11 illustrates a conventional initial desktop browser based application (in this example, the web resource is a store locator form that is displayed when a user clicks a “Find Store” link or button at a website (not shown)) and FIGS. 12-14 depict various diagrams showing an example implementation of operation according to an embodiment of the present disclosure (wherein the implementation is a conversion of the conventional initial desktop browser based application of FIG. 11).

More particularly, with reference first to FIG. 11, a web browser 1101 displaying “Find a Store” webpage of a fictional retail store is shown. As seen, included by the browser is a browser navigation bar 1103. Further, the webpage has various content, including Zip Code entry section 1105, street, city and state address entry section 1107 and find a store button 1109. These sections and this webpage are, of course, provided as examples only, and any desired webpage(s) and/or section(s) may be provided.

Referring now to FIG. 12, it is seen that mobile device 1201 includes browser 1203. Browser 1203 in turn includes browser navigation bar 1205. Further, displayed within browser 1203 is a mobile version of the webpage shown in FIG. 11 (this mobile version of the webpage may be displayed when a user clicks a “Find Store” link or button (not shown)). This mobile version may be generated using any of the conversion techniques described herein. As seen, this browser 1203 displays, in this example, Zip Code entry section 1105′ (along with an associated “Go” button 1207) and state/city entry section 1107′ (along with an associated “Go” button 1209). In addition, browser 1203 displays, in this example, update location button 1211 (which may be used, for example, to obtain location data from a GPS, from network information, or the like).

Referring now to FIG. 13, it is seen that a desired Zip Code (in this example, “27617”) has been entered into Zip Code entry section 1105′.

Referring now to FIG. 14, it is seen that “Go” button 1207 of FIG. 13 had been pressed and browser 1203 has now presented the user with a list stores 1401 that are near Zip Code 27617.

In various additional embodiments, new functionality may be added to the mobile website. One specific example where this becomes useful is related to interaction patterns for users. On desktop browsers, users are accustomed to typing in search fields to input things such as data for a store locator. In contrast, users on mobile devices are more accustomed to limiting the amount of typing that is done on the device—with interaction being focused more around touch enablement.

Thus, in various embodiments, certain parsing logic may include logic directed to visitor patterns. For example, a parser may be aware of a set of modern features (such as HTML5) that mobile devices can leverage. The parser may also be aware of how such modern features are typically surfaced to the user with regard to the user interface.

By leveraging these modern features, the mobile application views can provide more of a push versus pull interaction pattern (e.g., the device can determine the location of the user when providing location based services instead of the user having to type in the information). By being able to identify these patterns (e.g., by having a mapping of the list of features), various embodiments can provide a more tailored user experience based upon the features that are available on the device.

In one example, the concept of the visitor pattern would be a way to register a series of HTML parsers (i.e., visitors) that would allow the process to be extensible. In one specific example, a default set of parsers could be looking for specific HTML5 attributes (see, e.g., http://alebelcor.blogspot.com/2011/10/html5-apis.html for examples). In another specific example, provision may be made to extend the process to allow for custom parsers to look for newer features as they get added without requiring the previous code to be modified (i.e., add a new visitor).

More particularly, reference will now be made to FIG. 15 as an example use of a mobile store locator function using modern features (e.g., HTML5). During the conversion process (e.g., of a webpage of the type shown in FIG. 11 using any of the techniques described herein), features of the mobile device that may not be available for desktop browsers may be leveraged. One example of these features is geo-location, which was added as part of the HTML5 specification.

In this regard, when a user clicks a “Find Store” link or button (not shown) of a homepage of a website or another page, a user may be presented directly with the browser view of FIG. 15 (without needing to manually enter location information using the examples of FIGS. 12 and 13). Of note, the display of FIG. 15 is similar to that of FIG. 14 and includes, in this example, browser 1503, browser navigation bar 1505, and update location button 1511 (as displayed by mobile device 1501). In addition, displayed is a list of stores 1501 that are near Zip Code 27617.

In this example, the location information (e.g., Zip Code) may be automatically prepopulated. That is, when a user clicks a “Find Store” link or button (not shown) a geo-location API is used to obtain location information, the Zip Code is prepopulated, and a server is queried to provide the list of stores (this may all be done, for example, without user interaction). In one specific example, the Zip Code may be obtained by first getting latitude/longitude from the geo-location API and then converting the latitude/longitude (e.g., via a remote database) to a Zip Code. In another specific example, the Zip Code may be obtained by first getting network-based location information from the geo-location API and then converting the network-based location information (e.g., via a remote database) to a Zip Code.

Referring now to FIG. 16, a method of converting a web application to a mobile application for use on a mobile device is shown. As seen in this FIG. 16, the method of this embodiment comprises: at 1601—separating the web application into a static content and a dynamic content, the dynamic content comprising one or more data sources from which to retrieve data at runtime of the web application; at 1603—rendering the static content as one or more hypertext markup language pages with one or more links between the hypertext markup language pages converted to local links; at 1605—changing one or more references to the dynamic content to representational state transfer requests; at 1607—enabling the representational state transfer requests from the one or more hypertext markup language pages; at 1609—enabling use by the one or more hypertext markup language pages of at least one HTML5 feature that is accessible on the mobile device; and at 1611—packaging the one or more hypertext markup language pages as the mobile application.

In one example, the above steps may be carried out in the order recited or the steps may be carried out in another order.

Referring now to FIG. 17, a system 1700 for converting a web application to a mobile application is provided. This system may include the following elements: a processor 1701; and a conversion module 1703 operable to execute on the processor, the conversion module further operable to separate the web application into a static content and a dynamic content, the dynamic content comprising one or more data sources from which to retrieve data at runtime of the web application, the conversion module further operable to render the static content as one or more hypertext markup language pages with one or more links between the hypertext markup language pages converted to local links, the conversion module further operable to change one or more references to the dynamic content to representational state transfer requests to enable the representational state transfer requests from the one or more hypertext markup language pages, the conversion module further operable to enable use by the one or more hypertext markup language pages of at least one HTML5 feature that is accessible on the mobile device, wherein the one or more hypertext markup language pages are packaged as the mobile application.

In one example, communication between and among the various components of FIG. 17 may be bi-directional. In another example, the communication may be carried out via the Internet, an intranet, a local area network, a wide area network and/or any other desired communication channel(s). In another example, each of the components may be operatively connected to each of the other components. In another example, some or all of these components may be implemented in a computer system of the type shown in FIG. 9.

As described herein, mechanisms are provided for use of functionalities of a mobile device through HTML5 (such as determining location of a user) and providing results (e.g., in a visual form) to the user based on the use of the functionalities.

As described herein, various embodiments may be provided in the context of WEBSPHERE Application Servers.

As described herein, various embodiments may be provided in the context of next generation web application enablement (including WEB 2.0 and/or Rich Internet Application (RIA)).

As described herein, various embodiments may be provided in the context of: (a) Software: Application development software; and/or (b) Software: Application server middleware.

In other examples, features (e.g., APIs) associated with HTML5 and/or any other modern specification (see, e.g., http://alebelcor.blogspot.com/2011/10/html5-apis.html for examples) may be enabled as disclosed herein. Specific examples include (but are not limited to): Application Cache API, DataTransfer API, Command API, Constraint Validation API, History API, MediaController API, APIs for the text field selection, Canvas 2D Context, Clipboard API and events, Editing APIs, File API, File API: Directories and System, File API: Writer, HTML5 Web Messaging, Indexed Database API, Server-Sent Events, The Web Sockets API, Web Storage, Web Workers, XMLHttpRequest Level 2.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method of converting a web application to a mobile application for use on a mobile device, comprising:
separating the web application into a static content and a dynamic content, the dynamic content comprising one or more data sources from which to retrieve data at runtime of the web application;
rendering the static content as one or more hypertext markup language pages with one or more links between the hypertext markup language pages converted to local links;
changing one or more references to the dynamic content to representational state transfer requests;
enabling the representational state transfer requests from the one or more hypertext markup language pages;
enabling use by the one or more hypertext markup language pages of at least one HTML5 feature that is accessible on the mobile device; and
packaging the one or more hypertext markup language pages as the mobile application.

2. The method of claim 1, wherein the at least one HTML5 feature comprises a geo-location feature.

3. The method of claim 1, further comprising enabling adjustment of a user interface aspect of the one or more hypertext markup language pages in order to enable use of the at least one HTML5 feature.

4. The method of claim 1, further comprising parsing the web application and utilizing a result of the parsing to enable use by the one or more hypertext markup language pages of the at least one HTML5 feature.

5. The method of claim 4, further comprising utilizing visitor pattern information during the parsing.

6. The method of claim 1, wherein the packaged mobile application is stored to an app store for downloading to a user's mobile device.

7. The method of claim 1, wherein a mobile gateway on a remote server is utilized for accessing the dynamic content with the data sources.

8. The method of claim 1, wherein the web application comprises a web site.

9. The method of claim 1, wherein the changing one or more references to the dynamic content to representational state transfer requests comprises parsing the dynamic content of the web application, generating a data model comprising the one or more data sources, and refactoring the web application by removing one or more references to dynamic scripting that is executed on a server side, and inserting one or more of the representational state transfer requests for retrieving said one or more data sources.

10. The method of claim 8, wherein the inserting one or more of the representational state transfer requests for retrieving said one or more data sources comprises creating a JavaScript that includes the one or more of the representational state transfer requests and referencing the JavaScript from the one or more hypertext markup language pages.
